(19) United States
(12) Patent Application Publication
(10) Pub. No.: US 2009/0268961 A1
(43) Pub. Date: Oct. 29, 2009

(54) COLOR-SATURATION CONTROL METHOD

(75) Inventors: Ling-Chih LU, Hsinchu (TW); Ching-Hsiang HSU, Hsinchu (TW); Tang-Wei CHEN, Hsinchu (TW)

Correspondence Address: WPAT, PC, 7225 BEVERLY ST., ANNANDALE, VA, 22003, US

(73) Assignee: FARADAY TECHNOLOGY CORPORATION, Hsinchu (TW)

(21) Appl. No.: 12/427,293

(22) Filed: Apr. 21, 2009

(30) Foreign Application Priority Data
Apr. 25, 2008 (TW) 097115468

(51) Int. Cl. G06K 9/00

(52) U.S. Cl. 382/167

(57) ABSTRACT

For performing saturation control of one or more selected colors of the image, respective color values of the selected color(s) are pre-defined. Meanwhile, a specified pixel is selected from the image. Then distance(s) between the color space coordinate of the specified pixel and the color space coordinate(s) of the selected color(s) is (are) calculated. The color values of the specified pixel are thus adjusted depending on comparing results of the distance(s) with corresponding threshold distance(s).

### FIELD OF THE INVENTION

The present invention relates to a color-saturation control method, and more particularly to a color-saturation control method of an image performed by a digital image-processing device.

### BACKGROUND OF THE INVENTION

Digital image processing is a digitally data-processing and data-converting technique which divides an image into tiny pixels and presents color data of the pixels with digitized color models. Conventional and commonly used color models, for example, include a Red-Green-Blue (RGB) model, a Hue-Saturation-Value (HSV) model, a Luminance and Chrominance (YCbCr) model, etc. Take the RGB model as an example, three primary colors, i.e. red, green and blue, are mixed with various ratios so as to render different colors. Therefore, the color data of each pixel is composed of numeral values of the three primary colors in the RGB model. On the other hand, in the HSV model, the color data of each pixel is composed of numeral values of hue, saturation and value.

Varying with color models adopted, respective limitations are applied. The more limitation a color model has, the less number of colors the color model may present. As a result, color spaces, each of which represents all possible color combinations of a color model, are different for different color models. Conversion between color models is possible, e.g. from RGB model to HSV model or from RGB model to YCbCr model. Meanwhile, corresponding color space conversion will accompany the color model conversion.

Please refer to FIG. 1, in which a conventional saturation-adjusting device similar to that disclosed in US Patent Publication No. US 2005/0047657 is shown. The saturation-adjusting device 100 includes an RGB-HSV conversion unit 110, a saturation-adjusting-function setting unit 120, a saturation-adjusting unit 130 and an HSV-RGB conversion unit 140.

For displaying an image, the RGB-HSV conversion unit 110 receives R, G and B values of the image and converts the R, G and B values into H, S and V values. When a user intends to adjust color saturation for one or more specified colors of a displayed image, the user needs to input a saturation-adjusting value for the specified color into the saturation-adjusting-function setting unit 120 to set a saturation-adjusting function. According to the saturation-adjusting function, the saturation-adjusting unit 130 adjusts the saturation parameter of the H, S and V values outputted by the RGB-HSV conversion unit 110. Then new H, S′ and V values are obtained. The H, S′ and V values are then converted into new R′, G′ and B′ values by the HSV-RGB conversion unit 140.

As described above, the saturation-adjusting device 100 has to convert color models twice for adjusting color saturation. Since each color model conversion involves sophisticated calculation, the multiple conversions complicate the system design and result in high cost.

Referring to FIG. 2, a saturation-adjusting function outputted by the saturation-adjusting-function setting unit 120 is exemplified, wherein specified colors to be adjusted are indicated in the horizontal axis, and saturation-adjusting values that the user inputs into the saturation-adjusting-function setting unit 120 respectively for the specified colors, e.g. gains, are indicated in the vertical axis. For example, the gain of the red color is 96; the gain of the yellow color is 144; the gain of the green color is 80; the gain of the cyan color is 160; the gain of the blue color is 48; and the gain of the magenta color is 80. The above-mentioned gains constitute the saturation-adjusting function and are provided for the saturation-adjusting unit 130 to adjust the saturation parameter. According to the prior art, the saturation of the six specified colors are independently adjusted. Thus the adjustment would be subject to some limitations.

FIG. 3 illustrates another conventional method for controlling colors of a color image as disclosed in US Patent Publication No. US 2005/0219574. The method includes operations of color space conversion (Steps 320˜350), color control (Steps 310 and 360) and color space reversion (Steps 370 and 380). In the color space conversion steps, an RGB color space is converted into a YCbCr color space, while the YCbCr color space is converted into the RGB color space in the color space reversion steps. Hereinafter, the color control method is described step by step.

First of all, a color control variable is inputted by a user (Step 310), and a color image is inputted (Step 320). The system isolates a brightness component and a saturation component from the color image (Step 330), and extracts boundary values of a color gamut according to the brightness component and the saturation component (Step 340). Afterwards, the system converts an original color space into a modified color space (Step 350); controls color components according to the color control variable (Step 360); and reversely converts the modified color space into the original color space (Step 370). Finally, the color-controlled image is outputted (Step 380).

Since operations of color space conversion and color space reversion are performed as described above, the multiple conversion operations are disadvantageous in complicating the design and increasing cost.

U.S. Pat. No. 6,724,435 further discloses a method for independently controlling hue or saturation of individual colors in a real time digital video image. In the method, saturation of a specified color is independently adjusted. For example, in an RGB space, the saturation of the red color is calculated by the following formula:

Rₒᵤₜ=Rᵢₙ+[Sr*(255−Rᵢₙ)], Gₒᵤₜ=Gᵢₙ and Bₒᵤₜ=Bᵢₙ,

where Rᵢₙ, Gᵢₙ and Bᵢₙ are inputted color values of red, green and blue colors, respectively; Rₒᵤₜ, Gₒᵤₜ and Bₒᵤₜ are outputted color values of red, green and blue colors, respectively; and Sr is a user's setting for adjusting red saturation. It is obvious that only the red color value is changed. In other words, saturation of a specified color can be independently adjusted.

In another example, the saturation of the yellow color is to be adjusted. Since the yellow color is a mixed color of the red color and the green color, the saturation of the yellow color can be defined by:

Rₒᵤₜ=Rᵢₙ+0.5*[Sy*(255−max[Rᵢₙ,Gᵢₙ])], Gₒᵤₜ=Gᵢₙ+0.5*[Sy*(255−max[Rᵢₙ,Gᵢₙ])] and Bₒᵤₜ=Bᵢₙ,

where Sy is a user's setting for adjusting yellow saturation. It is obvious that only the red color value and the green color are changed as a result of the saturation adjustment of the yellow color. In other words, adjustment of saturation of a specified color can be independently done.

This method is advantageous in omission of color space conversion. However, it is limited in user's selection of colors for adjusting saturation.

### SUMMARY OF THE INVENTION

Therefore, an object of the present invention is to provide an image processing method for color adjustment of a colorful image, which allows a user to select any color in the image for independent saturation control.

An aspect of the present invention provides a color-saturation control method of an image performed by a digital image-processing device. The method includes steps of: selecting a specified color of the image with color values defined as a coordinate (r₀, g₀, b₀) in an RGB color space; selecting a specified pixel from the image with color values defined as a coordinate (Rₙ, Gₙ, Bₙ) in the RGB color space; calculating a distance between the coordinate (Rₙ, Gₙ, Bₙ) and the coordinate (r₀, g₀, b₀); and adjusting the color values of the specified pixel defined as the coordinate (Rₙ, Gₙ, Bₙ) into color values defined as a coordinate (Rₙ′, Gₙ′, Bₙ′) in the RGB color space if the distance between the coordinate (Rₙ, Gₙ, Bₙ) and the coordinate (r₀, g₀, b₀) is less than a threshold distance.

Another aspect of the present invention provides a color-saturation control method of an image performed by a digital image-processing device. The method includes steps of: selecting m specified colors of the image with respective color values defined as coordinates (r₁, g₁, b₁), (r₂, g₂, b₂), . . . (rₘ, gₘ, bₘ) in an RGB color space, where m is greater than 1; selecting a specified pixel from the image with color values defined as a coordinate (Rₙ, Gₙ, Bₙ) in the RGB color space; calculating distances Dₙ₁, Dₙ₂, . . . Dₙₘ between the coordinate (Rₙ, Gₙ, Bₙ) and the coordinates (r₁, g₁, b₁), (r₂, g₂, b₂), . . . (rₘ, gₘ, bₘ), respectively; obtaining a saturation gain variable with the distances Dₙ₁, Dₙ₂, . . . Dₙₘ; and adjusting the color values of the specified pixel defined as the coordinate (Rₙ, Gₙ, Bₙ) into color values defined as a coordinate (Rₙ′, Gₙ′, Bₙ′) in the RGB color space according to the saturation gain.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a scheme illustrating a color processing process of an image according to prior art;

FIG. 2 is a plot exemplifying saturation-adjusting-function settings of specific colors for use in the method of FIG. 1;

FIG. 3 is a flowchart of a conventional color control method;

FIG. 4 is a scheme illustrating a three dimensional RGB color space;

FIG. 5A is a flowchart of a color control method according to an embodiment of the present invention;

FIG. 5B is a plot exemplifying a saturation-adjusting function for use in the method of FIG. 5A;

FIG. 5C is a plot exemplifying another saturation-adjusting function for use in the method of FIG. 5A;

FIG. 6 is a flowchart of a color control method according to another embodiment of the present invention; and

FIG. 7 is a functional block diagram illustrating a typical LCD.

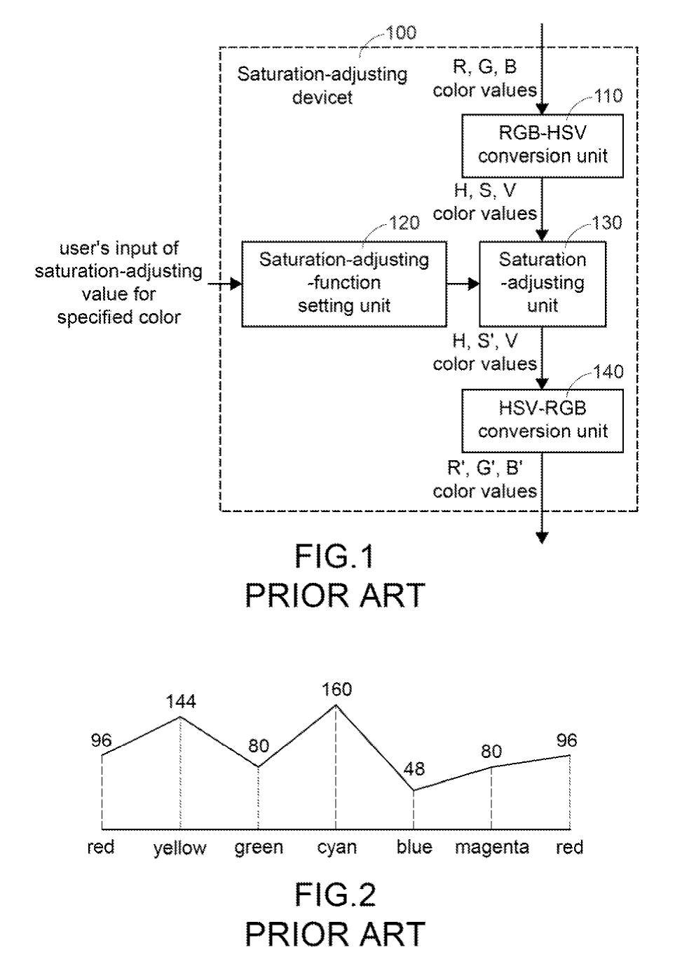

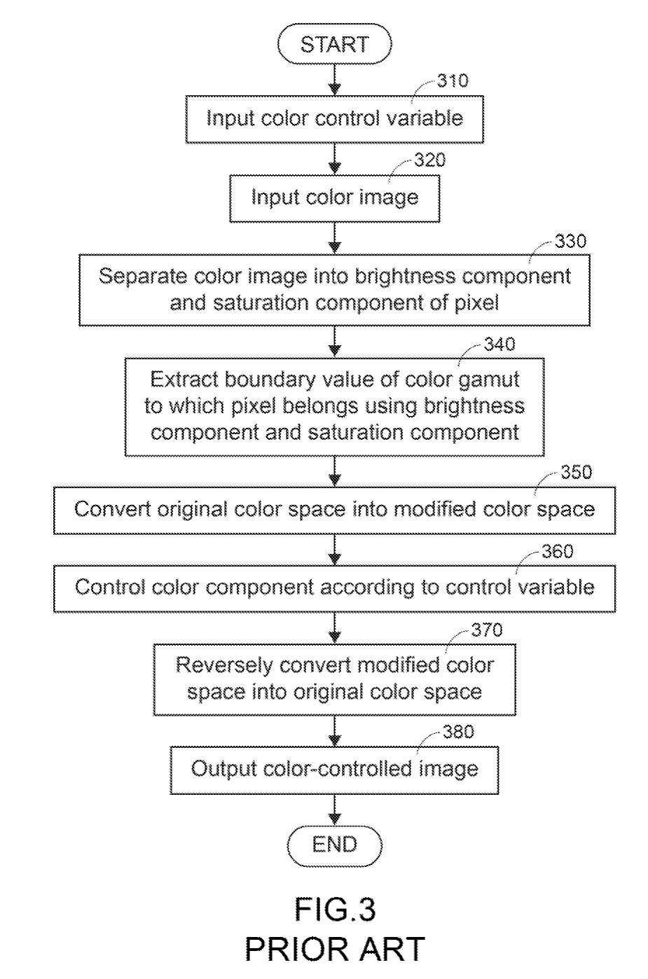

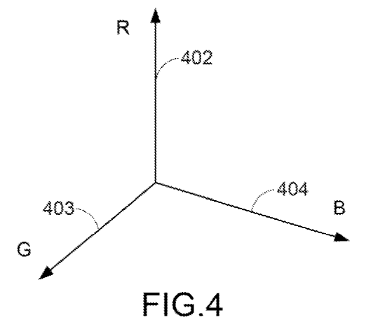

### DETAILED DESCRIPTION OF THE PREFERRED EMBODIMENT

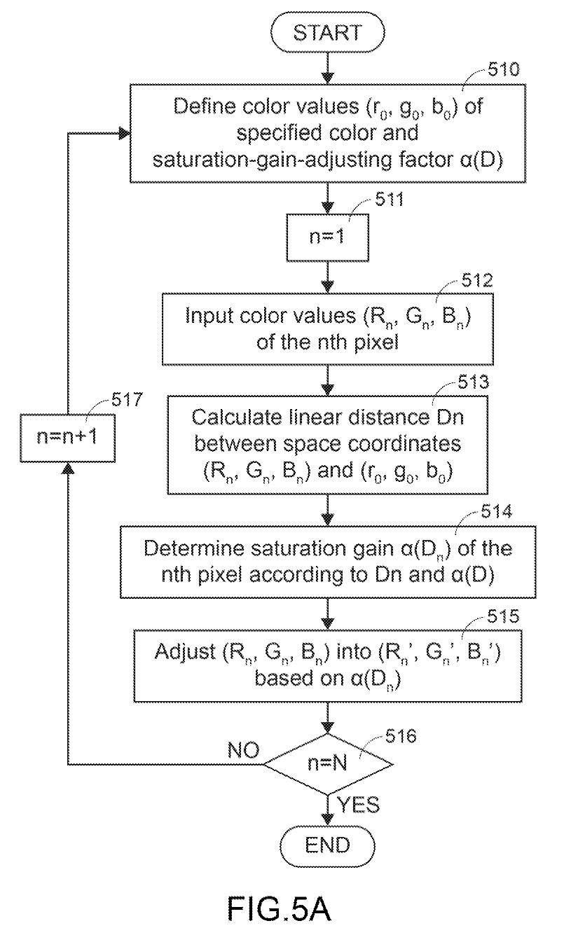

In an RGB color space, red, green and blue color values R, G and B are expressed as a space coordinate (R, G, B) for each pixel. According to an embodiment of the present invention, when a user select a specified color for saturation control, the system reads red, green and blue color values of the specified color, and converts the values into a corresponding space coordinate to be further processed. As shown in FIG. 4, the coordinate space is constituted by a red axis (R) 402, a green axis (G) 403 and a blue axis (B) 404.

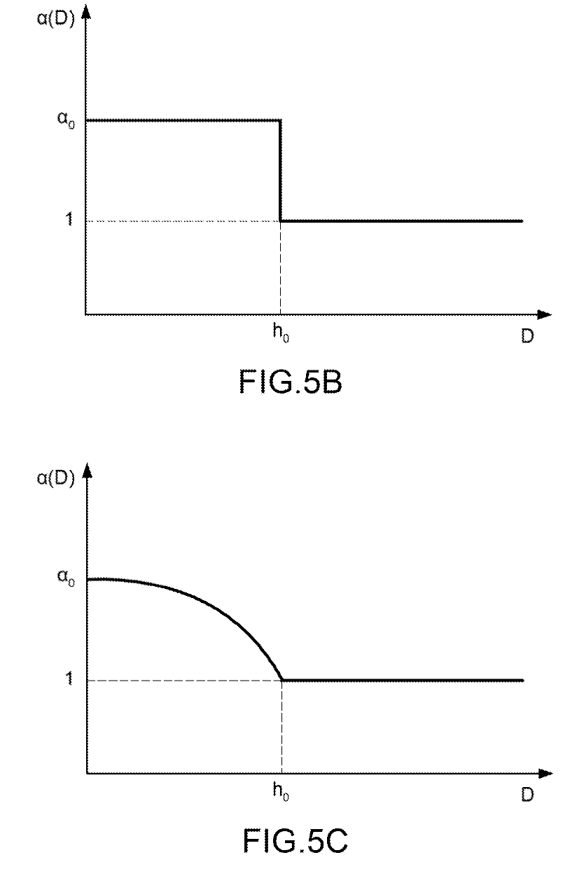

For example, when a user is to control saturation of a single specified color of an image, wherein the image includes N pixels, each pixel has corresponding color values expressed as a space coordinate (Rₙ, Gₙ, Bₙ) in the RGB color space, where 1≦n≦N, and color values of the specified color is expressed as a space coordinate (r₀, g₀, b₀), an embodiment of a method illustrated in the flowchart of FIG. 5A can be adopted.

First of all, the user defines the color values (r₀, g₀, b₀) of the specified color and a saturation-gain-adjusting factor α(D) (Step 510) and initially, n is preset as 1 (Step 511). The color values (Rₙ, Gₙ, Bₙ) of the nth pixel are inputted (Step 512) to be calculated with the color values (r₀, g₀, b₀) of the specified color (Step 513). A linear distance Dₙ between the space coordinate (Rₙ, Gₙ, Bₙ) and the space coordinate (r₀, g₀, b₀) is thus obtained as Dₙ=\sqrt{(Rₙ−r₀)²+(Gₙ−g₀)²+(Bₙ−b₀)²}. The linear distance Dₙ and the saturation-gain-adjusting factor α(D) are used to determine a saturation gain α(Dₙ) of the nth pixel (Step 514). Based on the saturation gain α(Dₙ), the color values (Rₙ, Gₙ, Bₙ) of the nth pixel are adjusted into color values (Rₙ′, Gₙ′, Bₙ′) (Step 515). Afterwards, the steps are repeated for saturation adjustment of the other pixels (Step 517) in sequence until all the N pixels are processed (Step 516).

Please refer to FIG. 5B which exemplifies the saturation-gain-adjusting factor α(D) defined by the user. As shown, the saturation-gain-adjusting factor α(D) is a function of the distance D, and a threshold distance h₀ is set. For a distance less than the threshold distance h₀, the saturation-gain-adjusting factor α(Dₙ) is equal to α₀; and for a distance greater than the threshold distance h₀, the saturation-gain-adjusting factor α(Dₙ) is equal to 1.

Accordingly, in the embodiment of FIG. 5A, if the distance Dn between the space coordinate (Rₙ, Gₙ, Bₙ) and the space coordinate (r₀, g₀, b₀) is less than the threshold distance h₀, the saturation gain α₀ is used to adjust the color values (Rₙ, Gₙ, Bₙ) of the nth pixel into the color values (Rₙ′, Gₙ′, Bₙ′). On the other hand, if the distance Dn between the space coordinate (Rₙ, Gₙ, Bₙ) and the space coordinate (r₀, g₀, b₀) is greater than the threshold distance h₀, the saturation gain 1 is applied so that the color values (Rₙ, Gₙ, Bₙ) of the nth pixel will not be adjusted, i.e., (Rₙ′, Gₙ′, Bₙ′)=(Rₙ, Gₙ, Bₙ).

Please be noted that the saturation-gain-adjusting factor α(D) can be varied and modified with practical requirements on color control. FIG. 5C shows another one of alternative examples of the saturation-gain-adjusting factor α(D). In this example, a threshold distance h₀ is also set. When the linear distance Dn between the nth pixel and the specified color is equal to 0, α(Dₙ)=α₀; for a distance less than the threshold distance h₀, the saturation gain α(Dₙ) decreases with the increase of the distance; and for a distance greater than the threshold distance h₀, the saturation gain α(Dₙ) is equal to 1.

It is understood from the above descriptions that the saturation control according to the present invention is not limited to specific colors. Instead, by presetting a specified color with color values (r₀, g₀, b₀) and a threshold distance h₀ in the RGB color space, the saturation control can be selectively performed. If the distance Dn between the space coordinate (Rₙ, Gₙ, Bₙ) of a pixel and the space coordinate (r₀, g₀, b₀) of the specified color is less than the threshold distance h₀, it is indicated that the color of the pixel is close to the specified color, so it is required to adjust saturation of the pixel. On the other hand, if the distance Dn between the space coordinate (Rₙ, Gₙ, Bₙ) of a pixel and the space coordinate (r₀, g₀, b₀) of the specified color is greater than the threshold distance h₀, it is indicated that the color of the pixel is not similar to the specified color, so it is not necessary to adjust saturation of the pixel. In other words, the setting of the threshold distance h₀ is to set a color range.

For example, the user defines that the specified color is blue and also properly defines the threshold distance h₀. In a case that the nth pixel is indigo color, since a distance between the indigo color and the blue color is less than the threshold distance h₀, the color values of the indigo colors will be adjusted for saturation control. In another case that the nth pixel is purple color, since a distance between the purple color and the blue color is also less than the threshold distance h₀, the color values of the purple colors will be adjusted for saturation control. In a further case that the nth pixel is orange color, since a distance between the orange color and the blue color is greater than the threshold distance h₀, the color values of the orange colors will not be adjusted. In brief, any color having a distance from the specified color within the threshold distance h₀ will be adjusted when the user intends to control saturation of the specified color. Hereinafter, the adjustment of color values will be described in more detail.

First of all, a luminance function Iₙ of the nth pixel, which is defined as Iₙ=(Rₙ+Gₙ+Bₙ)/3, is calculated according to the color values (Rₙ, Gₙ, Bₙ) of the nth pixel. Then the adjusted color values (Rₙ′, Gₙ′, Bₙ′) of the nth pixel can be obtained according to formulae: Rₙ′=(Rₙ−Iₙ)×α(Dₙ)+Iₙ; Gₙ′=(Gₙ−Iₙ)×α(Dₙ)+Iₙ and Bₙ′=(Bₙ−Iₙ)×α(Dₙ)+Iₙ.

When the saturation-gain-adjusting factor α(Dₙ) as illustrated in FIG. 5B is applied, it is realized that α(Dₙ) is equal to 1, i.e. (Rₙ′, Gₙ′, Bₙ′)=(Rₙ, Gₙ, Bₙ), when the distance Dn between the space coordinate (Rₙ, Gₙ, Bₙ) of the nth pixel and the space coordinate (r₀, g₀, b₀) of the specified color is greater than the threshold distance h₀. On the other hand, α(Dₙ) is equal to α₀ when the distance is less than the threshold distance h₀. Accordingly, the adjusted color values (Rₙ′, Gₙ′, Bₙ′) of the nth pixel become Rₙ′=(Rₙ−Iₙ)×α₀+Iₙ; Gₙ′=(Gₙ−Iₙ)×α₀+Iₙ and Bₙ′=(Bₙ−Iₙ)×α₀+Iₙ.

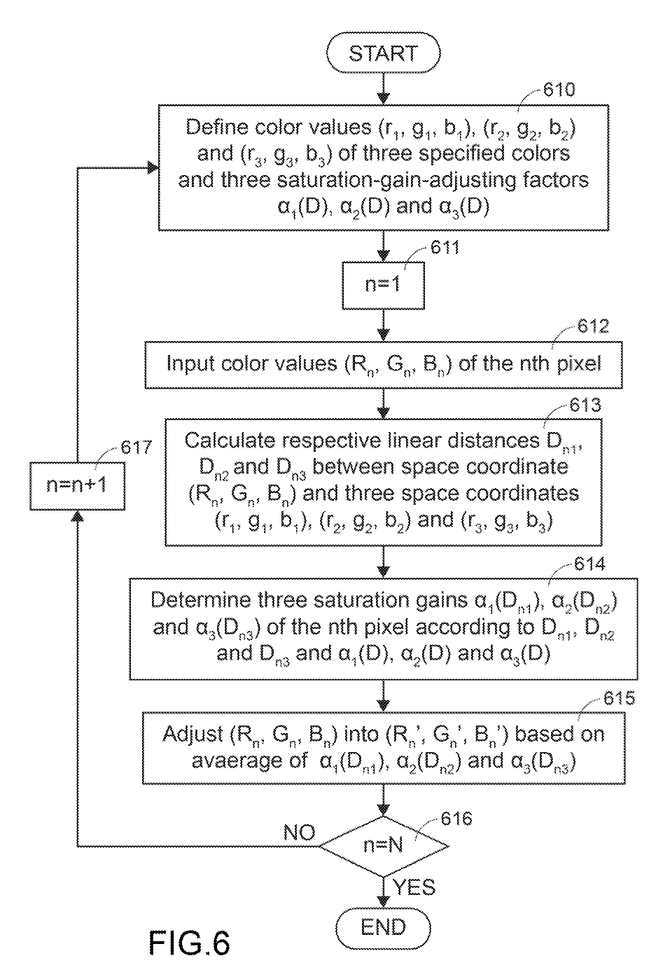

In a similar way, saturation of more than one color can be controlled at the same time according to the present invention. For example, saturation of three specified colors with color values expressed as space coordinates (r₁, g₁, b₁), (r₂, g₂, b₂) and (r₃, g₃, b₃) in the RGB color space are to be controlled. Likewise, assume that an image includes N pixels, each of which has color values expressed as a space coordinate (Rₙ, Gₙ, Bₙ), where 1 n N. FIG. 6 illustrates an embodiment of the saturation control method according to the present invention for achieving this purpose.

First of all, the user defines the color values (r₁, g₁, b₁), (r₂, g₂, b₂) and (r₃, g₃, b₃) of the three specified colors and three saturation-gain-adjusting factors α₁(D), α₂(D) and α₃(D) (Step 610) and initially, n is preset as 1 (Step 611). The color values (Rₙ, Gₙ, Bₙ) of the nth pixel are inputted (Step 612) to be calculated with the color values (r₁, g₁, b₁), (r₂, g₂, b₂) and (r₃, g₃, b₃) of the specified colors (Step 613). Respective linear distances Dₙ₁, Dₙ₂ and Dₙ₃ between the space coordinate (Rₙ, Gₙ, Bₙ) and the three space coordinates (r₁, g₁, b₁), (r₂, g₂, b₂) and (r₃, g₃, b₃) are thus obtained as:

Dₙ₁=\sqrt{(Rₙ−r₀)²+(Gₙ−g₀)²+(Bₙ−b₀)²}

Dₙ₂=\sqrt{(Rₙ−r₁)²+(Gₙ−g₁)²+(Bₙ−b₁)²}

Dₙ₃=\sqrt{(Rₙ−r₂)²+(Gₙ−g₂)²+(Bₙ−b₂)²}

The linear distances Dₙ₁, Dₙ₂ and Dₙ₃ and the saturation-gain-adjusting factors α₁(D), α₂(D) and α₃(D) are used to determine three saturation gains α₁(Dₙ₁), α₂(Dₙ₂) and α₃(Dₙ₃) of the nth pixel (Step 614). Based on the three saturation gains α₁(Dₙ₁), α₂(Dₙ₂) and α₃(Dₙ₃), an averaged saturation gain is obtained and the color values (Rₙ, Gₙ, Bₙ) of the nth pixel are adjusted into color values (Rₙ′, Gₙ′, Bₙ′) according to the averaged saturation gain (Step 615). Afterwards, the steps are repeated for saturation adjustment of the other pixels (Step 617) in sequence until all the N pixels are processed (Step 616).

In Step 610 of this embodiment, the color values (r₁, g₁, b₁), (r₂, g₂, b₂) and (r₃, g₃, b₃) are preset by the user to control saturation of the three specified colors. In addition, the saturation-gain-adjusting factor α₁(D) and a first threshold distance h₁ can be set for a first one of the three specified colors, the saturation-gain-adjusting factor α₂(D) and a second threshold distance h₂ can be set for a second one of the three specified colors, and the saturation-gain-adjusting factor α₃(D) and a third threshold distance h₃ can be set for a third one of the three specified colors according to practical requirements, e.g. in the same or different manners similar to that shown in FIG. 5B or FIG. 5C.

Subsequently, in Step 613 and Step 614, a distance Dₙ₁ between the space coordinate (Rₙ, Gₙ, Bₙ) of the nth pixel and the space coordinate (r₁, g₁, b₁) is calculated and compared with the threshold distance h₁ in order to determine the saturation gain α₁(Dₙ₁) based on the saturation-gain-adjusting factor α₁(D). For example, if the distance Dₙ₁ is greater than the threshold distance h₁, the saturation gain α₁(Dₙ₁) is equal to 1; and if the distance Dₙ₁ is less than the threshold distance h₁, the saturation gain α₁(Dₙ₁) is equal to α₁. Likewise, a distance Dₙ₂ between the space coordinate (Rₙ, Gₙ, Bₙ) of the nth pixel and the space coordinate (r₂, g₂, b₂) is calculated and compared with the threshold distance h₂ in order to determine the saturation gain α₂(Dₙ₂) based on the saturation-gain-adjusting factor α₂(D); and a distance Dₙ₃ between the space coordinate (Rₙ, Gₙ, Bₙ) of the nth pixel and the space coordinate (r₃, g₃, b₃) is calculated and compared with the threshold distance h₃ in order to determine the saturation gain α₃(Dₙ₃) based on the saturation-gain-adjusting factor α₃(D). For example, if the distance Dₙ₂ is greater than the threshold distance h₂, the saturation gain α₂(Dₙ₂) is equal to 1; if the distance Dₙ₂ is less than the threshold distance h₂, the saturation gain α₂(Dₙ₂) is equal to α₂; if the distance Dₙ₃ is greater than the threshold distance h₃, the saturation gain α₃(Dₙ₃) is equal to 1; and if the distance Dₙ₃ is less than the threshold distance h₃, the saturation gain α₃(Dₙ₃) is equal to α₃. The saturation gain equal to 1 means the saturation will not be adjusted. Subsequently in Step 615, the saturation gains α₁(Dₙ₁), α₂(Dₙ₂) and α₃(Dₙ₃) are averaged to obtain a saturation gain α_{avg} for saturation control. That is, the color values (Rₙ, Gₙ, Bₙ) of the nth pixel are adjusted into color values (Rₙ′, Gₙ′, Bₙ′) according to the averaged saturation gain α_{avg}.

It is understood from the above embodiments that saturation control for one or more colors is feasible according to the present invention. For saturation control of a single color, color values (r₀, g₀, b₀) of the color, a threshold distance h₀ and a saturation-gain-adjusting factor α(D) are preset; and for saturation control of three colors, color values (r₁, g₁, b₁), (r₂, g₂, b₂) and (r₃, g₃, b₃) of the three colors and respectively corresponding threshold distances h₁, h₂ and h₃ and saturation-gain-adjusting factors α₁(D), α₂(D) and α₃(D) are preset, and an averaged saturation gain α_{avg} is calculated. Accordingly, the color values (Rₙ, Gₙ, Bₙ) of the nth pixel are adjusted into color values (Rₙ′, Gₙ′, Bₙ′).

Similar operations can be applied to saturation control of m colors with the setting of color values of the m colors and respectively corresponding m threshold distances and m saturation-gain-adjusting factors, where m is greater than 1.

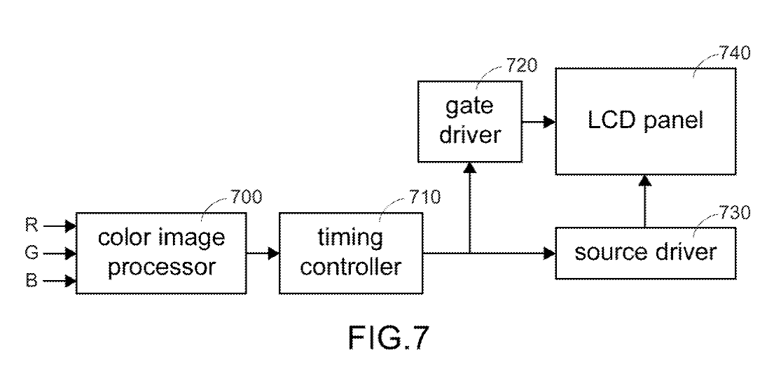

Please refer to FIG. 7, in which a functional block diagram of a liquid crystal display (LCD) is illustrated. Typically, the LCD includes a color image processor 700, a timing controller 710, a gate driver 720, a source driver 730, and an LCD panel 740. The color image processor 700 may further include a scalar. In this architecture, means for performing the color control method of the present invention can be disposed in the color image processor 700, timing controller 710 or the scalar.

In view of the foregoing, the present invention is advantageous in performing saturation control of non-specific color or colors. While the selected color or colors of an image are adjusted, saturation of the other colors in the image is not influenced. Although RGB color space is considered for the embodiments discussed with FIG. 4 to FIG. 7, the present invention also applies to other color spaces. Furthermore, though a unity value 1 of α(D) is exemplified in FIG. 5A and FIG. 5B for D larger than h₀, alternative value other than 1 can be set for D larger than h₀. Or a function where α(D) varies with D can also be adopted for D larger than h₀.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A color-saturation control method of an image performed by a digital image-processing device, comprising steps of:
selecting a specified color of the image with color values defined as a coordinate (r₀, g₀, b₀) in an RGB color space;
selecting a specified pixel from the image with color values defined as a coordinate (Rₙ, Gₙ, Bₙ) in the RGB color space;
calculating a distance between the coordinate (Rₙ, Gₙ, Bₙ) and the coordinate (r₀, g₀, b₀); and
adjusting the color values of the specified pixel defined as the coordinate (Rₙ, Gₙ, Bₙ) into color values defined as a coordinate (Rₙ′, Gₙ′, Bₙ′) in the RGB color space if the distance between the coordinate (Rₙ, Gₙ, Bₙ) and the coordinate (r₀, g₀, b₀) is less than a threshold distance.

2. The method according to claim 1, further comprising a step of remaining the color values of the specified pixel unchanged if the distance between the coordinate (Rₙ, Gₙ, Bₙ) and the coordinate (r₀, g₀, b₀) is greater than the threshold distance.

3. The method according to claim 1 wherein the adjustment of color values is performed by steps of:
providing a saturation-gain-adjusting factor α(D);
obtaining a saturation gain α(Dₙ) according to the saturation-gain-adjusting factor α(D) where Dₙ is the distance between the coordinate (Rₙ, Gₙ, Bₙ) and the coordinate (r₀, g₀, b₀); and
adjusting the color values of the specified pixel defined as the coordinate (Rₙ, Gₙ, Bₙ) into color values defined as the coordinate (Rₙ′, Gₙ′, Bₙ′) in the RGB color space according to the saturation gain α(Dₙ).

4. The method according to claim 1 wherein the adjustment of color values is performed by steps of:
providing a saturation-gain-adjusting factor α(D);
obtaining a first saturation gain α₀ according to the saturation-gain-adjusting factor α(D) when the distance between the coordinate (Rₙ, Gₙ, Bₙ) and the coordinate (r₀, g₀, b₀) is less than the threshold distance, and obtaining a second saturation gain a₀ according to the saturation-gain-adjusting factor α(D) when the distance between the coordinate (Rₙ, Gₙ, Bₙ) and the coordinate (r₀, g₀, b₀) is greater than the threshold distance;
providing a luminance value Iₙ of the specified pixel, which is a function of color values Rₙ, Gₙ and Bₙ; and
adjusting the color values of the specified pixel defined as the coordinate (Rₙ, Gₙ, Bₙ) into color values defined as the coordinate (Rₙ′, Gₙ′, Bₙ′) in the RGB color space, wherein Rₙ′=(Rₙ−Iₙ)×α₀+Iₙ; Gₙ′=(Gₙ−Iₙ)×α₀+Iₙ and Bₙ′=(Bₙ−Iₙ)×α₀+Iₙ when the first saturation gain α₀ is obtained according to the saturation-gain-adjusting factor α(D), and Rₙ′=(Rₙ−Iₙ)×a₀+Iₙ; Gₙ′=(Gₙ−Iₙ)×a₀+Iₙ and Bₙ′=(Bₙ−Iₙ)×a₀+Iₙ when the second saturation gain a₀ is obtained according to the saturation-gain-adjusting factor α(D).

5. The method according to claim 4 wherein the first saturation gain α₀ is greater than the second saturation gain a₀ which is equal to 1.

6. The method according to claim 4 wherein the luminance value Iₙ is equal to (Rₙ+Gₙ+Bₙ)/3.

7. A color-saturation control method of an image performed by a digital image-processing device, comprising steps of:
selecting m specified colors of the image with respective color values defined as coordinates (r₁, g₁, b₁), (r₂, g₂, b₂), . . . (rₘ, gₘ, bₘ) in an RGB color space, where m is greater than 1;
selecting a specified pixel from the image with color values defined as a coordinate (Rₙ, Gₙ, Bₙ) in the RGB color space;
calculating distances Dₙ₁, Dₙ₂, . . . Dₙₘ between the coordinate (Rₙ, Gₙ, Bₙ) and the coordinates (r₁, g₁, b₁), (r₂, g₂, b₂), . . . (rₘ, gₘ, bₘ), respectively;
obtaining a saturation gain variable with the distances Dₙ₁, Dₙ₂, . . . Dₙₘ; and
adjusting the color values of the specified pixel defined as the coordinate (Rₙ, Gₙ, Bₙ) into color values defined as a coordinate (Rₙ′, Gₙ′, Bₙ′) in the RGB color space according to the saturation gain.

8. The method according to claim 7 wherein the adjustment of color values is performed by steps of:
providing m saturation-gain-adjusting factors corresponding to the m specified colors, respectively;
obtaining m saturation gains according to the m saturation-gain-adjusting factors and the distances Dₙ₁, Dₙ₂, . . . Dₙₘ;
obtaining the saturation gain variable with the distances Dₙ₁, Dₙ₂, . . . Dₙₘ as an averaged saturation gain of the m saturation gains; and
adjusting the color values of the specified pixel defined as the coordinate (Rₙ, Gₙ, Bₙ) into color values defined as the coordinate (Rₙ′, Gₙ′, Bₙ′) in the RGB color space according to the averaged saturation gain.

9. The method according to claim 8 wherein the m saturation gains are obtained according to the m saturation-gain-adjusting factors and comparing results of the distances Dₙ₁, Dₙ₂, . . . Dₙₘ with corresponding threshold distances.

10. The method according to claim 7 wherein the adjustment of color values is performed by steps of:
providing m saturation-gain-adjusting factors corresponding to the m specified colors, respectively;
obtaining m saturation gains according to the m saturation-gain-adjusting factors and the distances Dₙ₁, Dₙ₂, . . . Dₙₘ;
obtaining the saturation gain variable with the distances Dₙ₁, Dₙ₂, . . . Dₙₘ as an averaged saturation gain of the m saturation gains;
providing a luminance value Iₙ of the specified pixel, which is a function of color values Rₙ, Gₙ and Bₙ; and
adjusting the color values of the specified pixel defined as the coordinate (Rₙ, Gₙ, Bₙ) into color values defined as the coordinate (Rₙ′, Gₙ′, Bₙ′) in the RGB color space, wherein Rₙ′=(Rₙ−Iₙ)×α_{avg}+Iₙ; Gₙ′=(Gₙ−Iₙ)×α_{avg}+Iₙ and Bₙ′=(Bₙ−Iₙ)×α_{avg}+Iₙ.

11. The method according to claim 4 wherein the luminance value Iₙ is equal to (Rₙ+Gₙ+Bₙ)/3.
